(19) United States
(12) Patent Application Publication
(10) Pub. No.: US 2006/0267507 A1
(43) Pub. Date: Nov. 30, 2006

(54) Electron emission display and method of controlling voltage thereof

(76) Inventor: Duck Gu Cho, Changnyeong-gun (KR)

Correspondence Address: LEE & MORSE, P.C., 3141 FAIRVIEW PARK DRIVE, SUITE 500, FALLS CHURCH, VA, 22042, US

(21) Appl. No.: 11/442,454

(22) Filed: May 30, 2006

(30) Foreign Application Priority Data
May 27, 2005 (KR) 10-2005-0044987

(51) Int. Cl. G09G 3/10; G09G 3/22

(52) U.S. Cl. 315/169.2; 345/75.2

(57) ABSTRACT

To increase the brightness and/or the life-time of a display, an anode voltage signal may be controllably adjusted during operation of the display. The method may involve, receiving at least one of image signals and external control signals, determining an anode current value for anode current flowing through the anode electrode based on the received at least one of the image signals and the external control signals, comparing the determined anode current value with a reference current value and outputting a comparison result, and adjusting an anode voltage signal to be supplied to the anode electrode based on the comparison result.

### BACKGROUND OF THE INVENTION

1. Field of the Invention

The present invention relates to an electron emission display and a method of controlling the voltages of such electron emission display. More particularly, the present invention relates to an electron emission display capable of determining anode currents or emission currents, respectively flowing through anode electrodes or electron emission devices of the electron emission display based on input image signals and/or external input signals to control anode voltages based on the determined emission or anode currents to increase brightness and prolong the life-time of the electron emission devices, and a method of controlling the voltages of such electron emission displays.

2. Discussion of Related Art

Flat panel displays (FPDs) may include side walls between two substrates to provide an airtight space in which material(s) for displaying images may be arranged. The demand for FPDs is increasing with the development of multimedia. Various types of FPDs such as liquid crystal displays (LCDs), plasma display panels (PDPs) and electron emission displays have been developed and are being used.

Electron emission displays generally employ an electron beam, similar to cathode ray tubes (CRTs), for energizing fluorescent material(s) to emit light. Thus, electron emission displays have the advantages of both CRTs and flat panel displays while also generally consuming a relatively low amount of power and being capable of displaying images with no or a relatively low amount of distortion. Electron emission displays generally have relatively fast response times, relatively high brightness levels and relatively fine pitches. Electron emission displays are also generally relatively thin in relation to other display devices.

Electron emission devices generally employ hot cathodes or cold cathodes as electron sources for the electron beams. Examples of electron emission displays using cold cathodes include field emitter array (FEA) type displays, surface conduction emitter (SCE) type displays, metal-insulator-metal (MIM) type displays, metal-insulator-semiconductor (MIS) type displays, and ballistic electron surface emitting (BSE) type displays, etc.

Electron emission displays may have a triode structure including a cathode electrode, an anode electrode and a gate electrode. The cathode electrode, which may correspond to a scan electrode, may be formed on a substrate. An insulating layer, with a hole formed therein, and the gate electrode, which may correspond to a data electrode, may be sequentially formed on the cathode electrode. An emitter may be formed as the electron source within the hole in the insulating layer and may contact the cathode electrode.

In electron emission displays with such a configuration, the emitter may emit electrons when a high electric field is focused on the emitter. Such electron emission may be explained by the quantum tunneling effect. The electrons emitted from the emitter may be accelerated by a voltage applied between the cathode electrode and an anode electrode and may collide with red, green and blue (RGB) fluorescent materials provided on the anode electrode. Collisions of the emitted electrons with the red, green and blue fluorescent materials may cause the fluorescent materials to emit respectively colored light, thereby displaying a predetermined image.

Brightness of an image displayed as a result of the collisions of the emitted electrons with the fluorescent materials may vary based on values of an input digital video signal. The input digital video signal may have an 8 bit value for each of red (R), green (G) and blue (B) data. For example, the digital video signal may have a value ranging from 0(00000000₍₂₎) to 255(11111111₍₂₎). Thus, such 8-bit input data signals may represent 256 possible values and may be used to represent a desired one of the 256 possible gray levels.

A pulse width modulation (PWM) method or a pulse amplitude modulation (PAM) method may be used to control the brightness represented by the values of the digital video signal.

The PWM method may modulate the pulse width of a driving waveform applied to the respective data electrode based on the digital video signals input to a data driver. For example, with such 8-bit input data signals, when the input digital video signal has a value of 255, the pulse width is maximized, thereby maximizing the allowable on-time and the brightness during a predetermined period of time. With such 8-bit input data signals, when the input digital video signal has a value of 127, the pulse width has about half of the maximum pulse width and about half of the maximum brightness during a predetermined period of time. Thus, the brightness of a pixel may be controlled by adjusting the width of the pulses in the waveform that is applied to that pixel based on the corresponding input digital video signal.

In comparison to the PWM method, the PAM method keeps the pulse width constant regardless of the input digital video signal and modulates the pulse voltage level, i.e., the pulse amplitude, of the driving waveform applied to the data electrode in accordance with the input digital video signal. Thus, the brightness of a pixel may be controlled by adjusting the amplitude of the pulses in the waveform that is applied to that pixel based on the corresponding input digital video signal.

The brightness of known electron emission displays generally deteriorates over time. In an attempt to increase the brightness and the lifetime of such known electron emission displays, voltages between the cathode electrodes and the anode electrodes may be increased. However, there are limitations on the amount that such voltages may be increased for white emission to occur.

### SUMMARY OF THE INVENTION

The present invention is therefore directed to an electron emission display and a method of controlling a voltage of an electron emission display, which substantially overcome one or more of the problems due to the limitations and disadvantages of the related art.

It is therefore a feature of embodiments of the invention to provide a method for controlling a voltage difference between respective gate electrodes and cathode electrodes of an electron emission display by controlling an anode voltage being supplied to the anode electrode(s) of the electron emission display if a measured anode current value is less than a reference current value.

It is therefore a feature of separate embodiments of the invention to provide a method of controlling a voltage difference between gate respective gate electrodes and cathode electrodes of an electron emission display by driving the current flowing through the anode electrode(s) of the electron emission display to equal a reference current value by adjusting a voltage signal of a gate electrode and/or a cathode electrode if a voltage difference between the gate electrode and the cathode electrode is below a maximum amount and by adjusting a voltage signal of the anode electrode if the voltage difference between the gate electrode and the cathode electrode is at the maximum amount.

At least one of the above and other features and advantages of the present invention may be realized by providing a an electron emission display that may include a pixel unit including an anode electrode, a controller, the controller receiving at least one of image signals and external control signals and outputting internal control signals to a power supply unit, the internal control signals may include signals for determining anode current flowing through the anode electrode based on the received image signals and/or the external control signals, and a power supply unit, the power supply unit. The power supply unit may include a determining unit, the determining unit may determine the anode current based on the internal control signals, a comparing unit, the comparing unit may compare the determined anode current value to a reference current value and outputting a comparison result, and a voltage controller, the voltage controller may adjust an anode voltage signal to be supplied to the anode electrode based on the comparison result.

The voltage controller may adjust the anode voltage signal to increase the anode current when the comparison result provides that the determined anode current value is less than the reference current value. The pixel unit may further include a plurality of cathode electrodes and a plurality of gate electrodes and the power supply unit may supply a cathode voltage signal, a gate voltage signal and the anode voltage signal to the cathode electrodes, the gate electrodes and the anode electrode, respectively, and when the determined anode current value is less than the reference current value, the controller may first adjust at least one of the cathode voltage signal and the gate voltage signal before adjusting the anode voltage signal to drive the anode current to have a value closer to or equal to the reference current value. The electron emission display may further include a data driver, the data driver applying data signals to the pixel unit, and a scan driver, the scan driver applying scan signals to the pixel unit. The controller may output the data signals to the data driver and outputs the scan signals to the scan driver based on at least one of the received image signals and the received external control signals.

The pixel unit may further include a plurality of cathode electrodes and a plurality of gate electrodes and the power supply unit may be connected to the pixel unit via at least one voltage signal line for respectively supplying cathode voltage signals, gate voltage signals and the anode voltage signals to the cathode electrodes, the gate electrodes and the anode electrode based on the determined anode current and the reference current value. When the comparison result provides that the anode current is less than the reference current value, the controller may determine whether a voltage difference between respective ones of the gate electrodes and the cathode electrodes is at a maximum amount. When the controller determines that the voltage difference is below the maximum amount, the controller may control the power supply unit to adjust at least one of the cathode voltage signal and the gate voltage signal, and when the controller determines that the voltage difference is at the maximum amount, the controller may control the power supply unit to adjust the anode voltage signal. The voltage difference may be at the maximum amount when one of the cathode voltage signal and the gate voltage signal is respectively at a maximum cathode voltage signal value and a maximum gate voltage signal value and the other one of the cathode voltage signal and the gate voltage signal is respectively at a minimum cathode voltage signal value and a minimum gate voltage signal value.

The internal control signals may include signals to the power supply unit to control at least one of a value and a pulse width of the anode voltage signal being supplied to the anode electrode. The power supply unit may further comprise a microcomputer, the microcomputer receiving the internal control signals from the controller and outputting voltage signals to the voltage controller. The power supply unit may further comprise a DC converter, the DC converter receiving the anode voltage signals from the voltage controller and converting pulse widths of the anode voltage signals.

At least one of the above and other features and advantages of the present invention may be separately realized by providing a method of controlling an display including an anode electrode, cathode electrodes and gate electrodes. The method may involve receiving at least one of image signals and external control signals, determining an anode current value for anode current flowing through the anode electrode based on the received at least one of the image signals and the external control signals, comparing the determined anode current value with a reference current value and outputting a comparison result, and adjusting anode voltage signals to be supplied to the anode electrode based on the comparison result.

Adjusting the anode voltage signals may include adjusting the anode voltage signal when the comparison result provides that the determined anode current is less than the reference current value in order to drive the anode current value to be closer to or equal to the reference current value. The method may further involve determining whether a voltage difference between respective ones of the gate electrodes and the cathode electrodes is at a maximum amount when the comparison result provides that the anode current is less than the reference current value. Adjusting the anode voltage signals may involve adjusting at least one of a cathode voltage signal and a gate voltage signal when it is determined that the voltage difference is less than the maximum amount, and adjusting the anode voltage signal when it is determined that the voltage difference is at the maximum amount. The step of adjusting the anode voltage signal may comprise adjusting one of a value and a pulse width of the anode voltage signal being adjusted.

At least one of the above and other features and advantages of the present invention may be separately realized by providing an electron emission display including a pixel unit including an anode electrode, controlling means for receiving at least one of image signals and external control signals and outputting internal control signals, determining means for determining an amount of anode current flowing through anode electrode based on the internal control signals, comparing means for comparing the determined amount of anode current value to a reference current value and outputting a comparison result, and voltage controlling means for adjusting an anode voltage signal to be supplied to the anode electrode based on the comparison result.

The pixel unit may further include a plurality of cathode electrodes and a plurality of gate electrodes, and when the comparing means outputs that the determined anode current is less than the reference current value, adjusting the anode voltage signal in order to drive the anode current value closer to or to be equal to the reference current value, the voltage controlling means may adjust at least one of a gate voltage signal and a cathode voltage signal to be respectively supplied to the gate electrodes and the cathode electrodes before adjusting the anode voltage signal.

The electron emission display may further include voltage difference determining means for determining whether a voltage difference between respective ones of the gate electrodes and the cathode electrodes is at a maximum amount when the comparison result provides that the anode current value is less than the reference current value. The voltage adjusting means may adjust at least one of the cathode voltage signal and the gate voltage signal when it is determined that the voltage difference is less than the maximum amount, and may adjust the anode voltage signal when it is determined that the voltage difference is equal to the maximum amount.

In embodiments of one or more aspects of the invention, when external control signals are applied, the anode voltages corresponding to the external control signals are controlled to increase brightness so that it is possible to prolong the life of the electron emission device.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a block diagram of an exemplary embodiment of an electron emission display;

FIG. 2 illustrates a cross-sectional view of a portion of an exemplary pixel unit that may be employed by the electron emission display shown in FIG. 1;

FIG. 3 illustrates a block diagram of the power supply unit of FIG. 1;

FIG. 4 illustrates a schematic diagram of the comparing unit of FIG. 3; and

FIG. 5 illustrates a flowchart an exemplary method for controlling voltages of electron emission displays.

### DETAILED DESCRIPTION OF THE INVENTION

Korean Patent Application No. 2005-44987, filed on May 27, 2005, in the Korean Intellectual Property Office, and entitled: “Electron Emission Display and Method of Controlling Voltage Thereof,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration.

It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

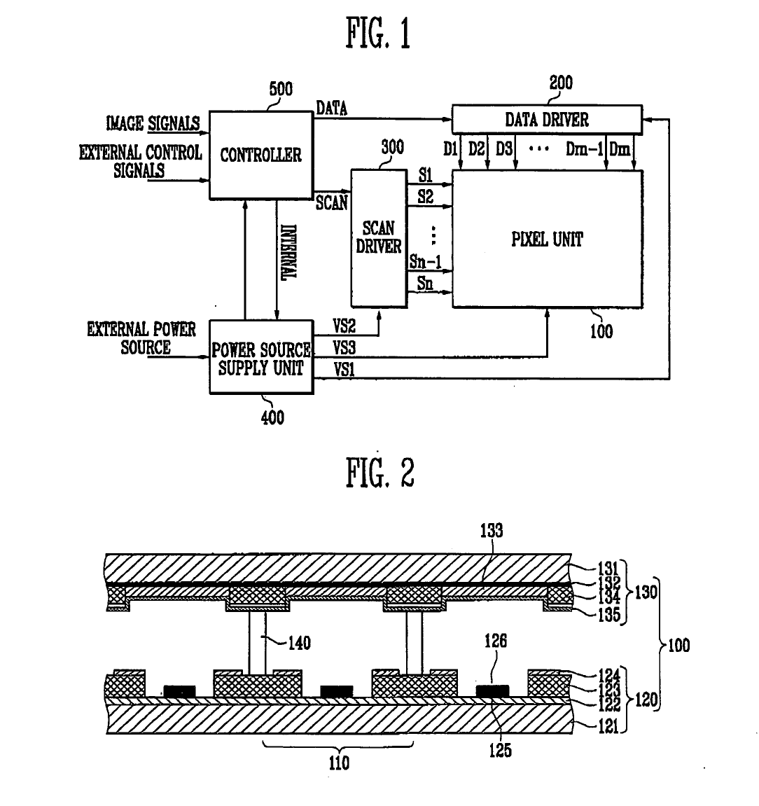

FIG. 1 illustrates a block diagram of an exemplary embodiment of an electron emission display and FIG. 2 illustrates a cross-sectional view of a portion of an exemplary pixel unit that may be employed by the electron emission display shown in FIG. 1. As shown in FIG. 1, the electron emission display may include a pixel unit 100, a data driver 200, a scan driver 300, a power supply unit 400 and a controller 500.

The pixel unit 100 may include n scan lines S1, S2, . . . , and Sn, m data lines D1, D2, . . . , and Dm and one or more anode electrode(s) 132 (shown in FIG. 2). Both n and m may be any number equal to or greater than 1. The scan lines S1, S2, . . . , and Sn and the data lines D1, D2, . . . , and Dm may be formed to intersect each other. The anode electrode 132 may be formed as a single electrode layer over the entire region of the pixel unit 100 or multiple anode electrodes 132 may be formed in various shapes. For example, the anode electrodes 132 may be provided in the form of a plurality of stripes extending along a row direction similar to the exemplary scan lines S1 to Sn, in the form of a plurality of stripes formed in a column direction similar to the exemplary data lines D1 to Dm or in the form of a mesh. A same anode voltage Va may be applied to the anode electrode(s) 132 of the electron emission display regardless of the form of the anode electrode(s) 132, e.g., in the form of a plurality of stripes or in the form of a mesh.

In embodiments of the invention, the electron emission display may include a plurality of electron emission units 110. FIG. 2 illustrates a cross-sectional view of a portion of the exemplary pixel unit 100 shown in FIG. 1. As illustrated in FIG. 2, the pixel unit 100 may include an electron emission substrate 120, an image forming substrate 130 and/or spacers 140. The spacers 140 may maintain a distance between the electron emission substrate 120 and the image forming substrate 130.

Each electron emission unit 110 may correspond to at least portion of a cathode electrode 122, at least a portion of a gate electrode 124 and at least a portion of the anode electrode(s) 132 between respective ones of the spacers 140. For example, each electron emission unit 110 may correspond to overlapping portions of at least one of the scan lines S1 to S1n and at least one of the data lines D1 to D1m. In such embodiments of the invention, the scan lines S1 to Sn may correspond to the cathode electrodes 122 or the gate electrodes 124 and the data lines D1 to Dm may correspond to the other of the cathode electrodes 122 or the gate electrodes 124.

The data driver 200 may apply data signals corresponding to input image signals IMAGE to the data lines D1, D2, . . . , and Dm. In the following description of exemplary embodiments of the invention, a data driver employing a pulse width modulation (PWM) method will be described. However, any type of data driver that controls the electron emission time of the electron emission units 110 in response to the input image signals IMAGE is included in the scope of the invention.

The scan driver 300 may sequentially apply scan signals to the scan lines S1, S2, . . . , and Sn.

The power supply unit 400 may be connected to the data driver 200 via a first voltage signal line VS1, may be connected to the scan driver 300 via a second voltage signal VS2 and may be connected to the anode electrode(s) 132 via a third voltage signal VS3. For example, the first voltage signal line VS1 may supply cathode voltages Vc to the cathode electrodes 122 via the data lines D1 to Dm. The second voltage signal line VS2 may supply gate voltages Vg to the gate electrodes 124 via the scan lines S1 to Sn. The third voltage signal line VS3 may supply the anode voltage(s) Va to the anode electrode(s) 132.

For example, in embodiments of the invention, the power supply unit 400 may receive internal control signals INTERNAL from the controller 500, determine value(s) of anode current Ia flowing through the anode electrode(s) 132 and compare the determined anode current Ia value(s) with a corresponding reference current Iref value(s). The power supply unit 400 may then control the voltages between the cathode electrodes 122 and the gate electrodes 124 and/or the voltage(s) of the anode electrode(s) 132 so that the voltages between the cathode electrodes 122 and the gate electrodes 124 and/or the voltage(s) of the anode electrode(s) 132 correspond to the reference current Iref value(s). When the power supply unit 400 controllably supplies a maximum voltage between the cathode electrode 122 and the gate electrode 124 and the anode current Ia does not correspond to the reference current value Iref, the anode voltage Va being supplied to the anode electrode 132 may be controlled.

The controller 500 may receive image signals IMAGE and/or external control signals EXTERNAL and may output data signals DATA corresponding to the image signals IMAGE and/or the internal control signals INTERNAL, which may be based on the external control signals EXTERNAL, to the data driver 200. The controller 500 may output the scan signals SCAN corresponding to the image signals IMAGE and/or the internal control signals INTERNAL to the scan driver 300. The controller 500 may output the internal control signals INTERNAL, which may be based on the external control signals EXTERNAL, to the power supply unit 400.

Voltages, e.g., Va, Vc, Vg, that may be supplied to the pixel unit 100 based on the image signals IMAGE and/or external control signals EXTERNAL may be adjusted based on the determined value of the anode current Ia. The brightness of the pixel unit 100 may be based on levels or values of the image signals IMAGE and/or the external control signals EXTERNAL. For example, the higher the levels of the image signals IMAGE, the brighter the pixel unit 100 and the lower the levels of the image signals IMAGE, the darker the pixel unit 100. The brightness of an image associated with one frame may correspond to an image level obtained by adding the levels or values of the data signals associated with the input image signals IMAGE and/or the external control signals EXTERNAL for that one frame.

In the following description of exemplary embodiments, emission current may correspond to electrons emitted by a respective one of the electron emission devices 125. Anode current Ia may correspond to current flowing from the power source supply unit 400 via, for example, the third voltage signal line VS3 to the anode electrode(s) 132. In embodiments of the invention, a magnitude of the anode current Ia may correspond to a magnitude of the emission current. The anode current Ia or the emission current may be determined directly by measuring the respective current. The anode current Ia or the emission current may be determined indirectly based, for example, on determined respective operating parameters of the power supply unit 400.

The controller 500 may apply internal control signals INTERNAL based on the external control signals EXTERNAL and/or the image signals IMAGE to the power supply unit 400. The internal control signals INTERNAL may initiate determination of the anode currents Ia corresponding to the image signals IMAGE and/or the external control signals EXTERNAL. For example, the controller 500 may supply the internal control signals INTERNAL to the power supply unit 400, and the power supply unit 400 may determine the anode current Ia based on the received internal control signals INTERNAL. Based on values of the determined anode currents Ia, a voltage difference Vcg between respective cathode electrodes 122 and gate electrodes 124 or the anode electrodes 132 may be adjusted, e.g., increased, so that a predetermined amount of current, e.g., a reference current amount, may flow through the anode electrode(s) 132. The image signals IMAGE may be input in real time and the external control signals EXTERNAL may be input by a user to control, for example, brightness. The anode current Ia may be determined at a point in time when the power is turned on so that the corresponding internal control signals INTERNAL may be supplied.

The internal control signals INTERNAL may include a reference current value Iref. For example, the controller 500 may provide internal control signal(s) INTERNAL including the reference current value Iref to the power supply unit 400 and the power supply unit 400 may compare the reference current value Iref with received determined values of the anode current Ia. In other embodiments of the invention, the controller 500 may obtain or receive the reference current Iref value and the determined values of the anode current Ia and may compare the determined anode currents Ia with the reference current Iref value. In such embodiments of the invention, the power supply unit 400 may supply the determined values of the anode current Ia to the controller 500. In embodiments of the invention, the reference current value Iref may be stored in a memory unit (not shown) of the electron emission display or the controller 500.

Based on the comparison results Rcomp between the determined anode current(s) Ia and the reference current Iref value, the power supply unit 400 may change the level of at least one of the cathode electrode voltage Vc, the gate electrode voltage Vg and the anode electrode voltage Va that may be respectively supplied via the first, second and third voltage signal lines VS1, VS2 and VS3. Therefore, the voltage levels of the data signals DATA and the scan signals SCAN respectively output from the data driver 200 and the scan driver 300 may be changed so that voltage differences between respective ones of the gate electrodes 124 and the cathode electrodes 122 of electron emission units 110 may be changed. Thus, brightness and life-time of the electron emission units 110 may be increased based on the comparison result Rcomp.

When the data lines D1 to Dm correspond to the cathode electrodes 122 and the scan lines S1 to Sn correspond to the gate electrodes 124, and the anode current Ia value is smaller than the reference current Iref value, the data driver 200 may increase the voltages Vc applied to the data lines D1 to Dm and/or the scan driver 300 may increase the gate electrode voltages Vg applied to the scan lines S1 to Sn. In embodiments of the invention, one of the cathode electrode voltages Vc or the gate electrode voltages Vg may be maintained constant while the other of the cathode electrode voltages Vc or the gate electrode voltages Vg are adjusted to generate a desired voltage difference Vcg between the respective gate electrodes 124 and cathode electrodes 122.

When the voltage between the cathode electrode 122 and the gate electrode 124 of the electron emission unit 110 is at a maximum amount and the value of the determined anode current Ia does not reach the reference current value Iref, the controller 500 may supply an internal control signal INTERNAL to the power supply unit 400 to increase the anode voltage Va being supplied via the third voltage signal line VS3.

As described above, a voltage difference between the cathode voltage and the gate voltage or the anode voltage may be adjusted, e.g., increased, to help control electron emission so that the contrast of images being displayed and the life-span of the electron emission units 110, and thus the electron emission display, may be improved.

As illustrated in FIG. 2, the pixel unit 100 may include the electron emission substrate 120 and the image forming substrate 130. The electron emission substrate 120 may emit electrons based on the voltages between the cathode electrodes 122 and the gate electrodes 124. The electron emission substrate 120 may include a bottom surface substrate 121, the cathode electrodes 122, insulating layers 123, the gate electrodes 124 and electron emission devices 125.

The bottom surface substrate 121 may be formed of, e.g., glass or silicon. The electron emission devices 125 may be formed using a photosensitive carbon nanotube (CNT) paste through the bottom surface substrate 121 formed of a transparent material. The transparent material may be, e.g., glass and the glass may be coated with, e.g., indium tin oxide (ITO).

The cathode electrodes 122 may be provided in the form of stripes on the bottom surface substrate 121. The data signals DATA or the scan signals SCAN applied from the data driver 200 or the scan driver 300 may be supplied to the cathode electrodes 122. The cathode electrodes 122 may be formed of conductive material(s). For example, the cathode electrodes 122 may be transparent electrodes formed of ITO.

The insulating layers 123 may be formed on the bottom surface substrate 121 and the cathode electrodes 122. The insulating layers 123 may electrically insulate the cathode electrodes 122 and the gate electrodes 124 from each other. The insulating layers 123 may be formed of insulating material such as glass obtained by mixing PbO and SiO₂ with each other.

The gate electrodes 124 may be formed on the insulating layers 123. The gate electrodes 124 may be formed in a predetermined shape, e.g., in stripes crossing or overlapping the cathode electrodes 122. The data signals DATA or the scan signals SCAN from the data driver 200 or the scan driver 300 may be supplied to the gate electrodes 124. The gate electrodes 124 may be formed of e.g., a metal having high conductivity. For example, the gate electrodes 124 may be formed of Au, Ag, Pt, Al, Cr, etc. and/or alloys of such metals. The insulating layers 123 and the gate electrodes 124 may include at least one aperture 126 at each of the intersections between the cathode electrodes 122 and the gate electrodes 124. The apertures 126 may expose respective portions of the cathode electrodes 122.

The electron emitting units 125 may be electrically connected to respective portions of the cathode electrodes 122. The electron emitting units 125 may be electrically connected to respective portions of the cathode electrodes 122 at respective portions of the cathode electrodes 122 exposed by the first apertures 126. The electron emitting units 125 may be formed of e.g., carbon nanotube, graphite, diamond, diamond-shaped carbon, nanotube obtained by combining, e.g., the above noted materials, nanowire formed of Si, SiC, etc.

The electrons emitted from the electron emission substrate 120 may collide with the image forming substrate 130 to emit light so that images may be formed and displayed. The image forming substrate 130 may include a top surface substrate 131, the anode electrode(s) 132, fluorescent elements 133, light shielding layers 134 and a reflecting layer 135.

The top surface substrate 131 may be formed of transparent material, e.g., glass, so that the light emitted from the fluorescent elements 133 may be transmitted to the outside of the electron emission display.

The anode electrodes 132 may be formed of transparent metal, e.g., ITO, so that the light emitted from the fluorescent elements 133 may be transmitted to the outside. The anode electrodes 132 may accelerate the electrons emitted from the electron emission units 110. Therefore, high positive (+) voltages may be applied to the anode electrodes 132 to accelerate the electrons in the direction of the fluorescent elements 133.

The fluorescent elements 133 may be selectively arranged on the anode electrodes 132. The fluorescent elements may be spaced a predetermined distance apart from each other. Images may be displayed based on light that may be emitted when the electrons emitted from the electron emission substrate 120 collide with the fluorescent elements 133. The fluorescent elements may be formed of a variety of different fluorescent materials and different colored fluorescent elements may be used. For example, the fluorescent elements may include red R fluorescent elements, green G fluorescent elements, blue B fluorescent elements, etc.

The G fluorescent elements may be formed of, e.g., ZnS:Cu, Zn₂SiO₄:Mn, ZnS:Cu+Zn₂SiO₄:Mn, Gd₂O₂S:Tb, Y₃Al₅O₁₂:Ce, ZnS:Cu, Al, Y₂O₂S:Tb, ZnO:Zn, ZnS:Cu,Al+In₂O₃, LaPO₄:Ce,Tb,BaO.6Al₂O₃:Mn, (Zn,Cd)S:Ag, (Zn, Cd)S:Cu,Al,ZnS:Cu,Au,Al, Y₃(Al,Ga)₂O₁₂:Tb, Y₂SiO₅:Tb, LaOCl:Tb, etc. The R fluorescent elements may be formed of, e.g., Y₂O₂S:Eu, Zn₃(PO₄)₂:Mn, Y₂O₃:Eu, YVO₄:Eu, (Y, Gd)BO₃:Eu, γ-Zn₃(PO₄)₂:Mn, (ZnCd)S:Ag, (ZnCd)S:Ag+In₂O₃, Y₂O₂S:Eu to which Fe₂O₃ is added, etc. The B fluorescent elements may be formed of, e.g., ZnS:Ag, ZnS:Ag,Al, ZnS:Ag,Ga,Al, ZnS:Ag,Cu,Ga,Cl, ZnS:Ag+In₂O₃, Ca₂B₅O₉Cl:Eu²+, (Sr,Ca,Ba, Mg)₁₀(PO₄)₆Cl₂:Eu²⁺, Sr₁₀(PO₄)₆C₂:Eu²⁺, BaMgAl₁₆O₂₆:Eu²⁺, ZnS:Ag to which CoO,Al₂O₃ is added, ZnS:Ag, Ga, etc.

The light shielding layers 134 may absorb and intercept external light and may reduce and/or prevent optical cross talk to improve contrast. The light shielding layers 134 may be arranged between the fluorescent elements 133 by a predetermined distance.

The reflecting layer 135 may be formed on the fluorescent elements 133. The reflecting layer 135 may be formed of metal. The reflecting layer 135 may collect the electrons emitted from the electron emission substrate 120 and may reflect light emitted from the fluorescent elements 133 as a result of, e.g., electron collisions with the fluorescent elements 133. By reflecting the light emitted from the fluorescent elements 133, the reflecting layer 135 may help improve the reflection effect and the brightness of the display. In embodiments of the invention, the reflecting layer 135 may operate as the anode electrodes 132 and it may not be necessary to separately form the anode electrodes 132.

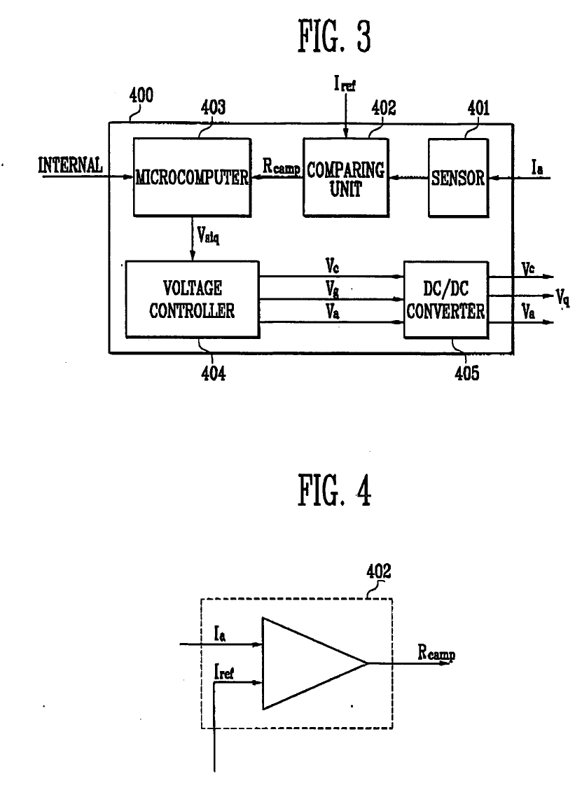

FIG. 3 illustrates a block diagram of the power supply unit of FIG. 1. As illustrated in FIG. 3, the power supply unit 400 may include a sensor 401, a comparing unit 402, a microcomputer 403, a voltage controller 404 and a DC converter 405.

The sensor 401 may receive the anode current Ia and may thereby determine the value of the anode current Ia flowing through the anode electrode(s) 132. The sensor 401 may determine the value of the anode current Ia when power is turned on and/or when the image signals IMAGE and/or the external control signals EXTERNAL are applied.

The comparing unit 402 may receive the anode current Ia value determined by the sensor 401. The comparing unit 402 may compare the anode current Ia value determined by the sensor 401 with the corresponding reference current value Iref and may output a comparison result Rcomp.

The microcomputer 403 may control voltages, e.g., Va, Vc and Vg being supplied by the first, second and/or third voltage signals lines VS1, VS2 and VS3, based on the comparison result Rcomp obtained by the comparing unit 402. The microcomputer 403 may generate and output a voltage signal Vsig to the voltage controller 404 for controlling the anode voltage Va, the cathode voltage Vc and/or the gate voltage Vg being supplied to the pixel unit 100.

The voltage controller 404 may supply the anode voltage Va, the cathode voltage Vc and/or the gate voltage Vg using the voltage signal(s) Vsig received from the microcomputer 403. The DC converter 405 may convert widths of one or more of the voltage signals Va, Vc, Vg received from the voltage controller 404. The voltage control signals Vsig may be used by the voltage controller 404 to adjust voltages Va, Vc, Vg being supplied to the data driver 200, the scan driver 300 and/or the anode electrode(s) 132 via the first, second and third voltage signal lines VS1, VS2, VS3 based on the comparison result Rcomp.

In embodiments of the invention, a cathode-gate voltage difference Vcg signal (not shown) may be processed by the DC converter 405 and supplied to one of the cathode electrodes 122 or the gate electrodes 124, while the other of the cathode electrode or the gate electrode 124 is supplied with a constant voltage signal. In such embodiments, the cathode-gate voltage Vcg may replace the cathode voltage Vc and the gate voltage Vg signals shown in FIG. 3.

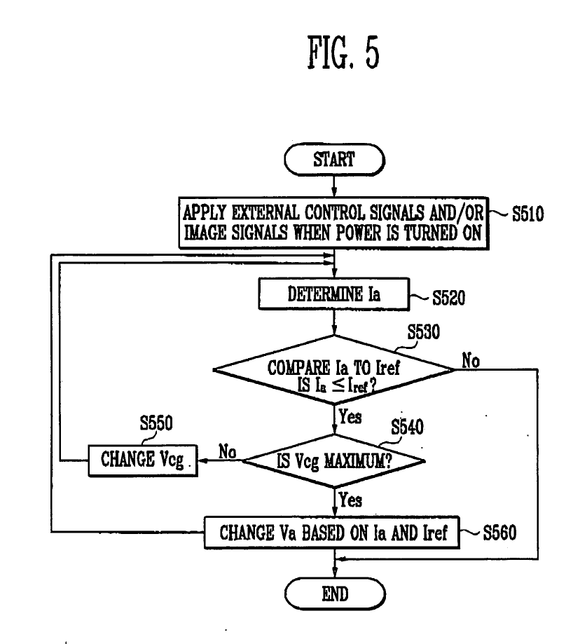

FIG. 4 illustrates a schematic of the comparing unit of FIG. 3. As shown in FIG. 4, the comparing unit 402 may receive the reference current value Iref from the controller 500 and may receive the anode current value 1a from the sensor 401 when the image signals IMAGE or the external control signals EXTERNAL are applied and may compare the reference current value Iref with the anode current value 1a and output the comparison result Rcomp. The comparing unit 402 may output the comparison result Rcomp to the microcomputer 403.

In embodiments of the invention, when the anode current Ia value is smaller than the reference current Iref value, the comparing unit 402 may control the level of the voltage between the cathode electrode 122 and the gate electrode 124 to cause the anode current Ia flowing through the anode electrode(s) 132 to correspond to the reference current Iref value, e.g., to increase the anode current Ia. If adjusting the voltage between the cathode electrode 122 and the gate electrode 124 is not sufficient to make the anode current Ia value correspond to the reference current Iref value, the level of the anode voltage Va may be controlled to cause the anode current Ia flowing through the anode electrode(s) 132 to correspond to the reference current Iref value. For example, the anode voltage Va may be adjusted when the voltage difference between the cathode electrode 122 and the gate electrode 124 reaches a maximum and the anode current Ia is still less than the reference current Iref value.

The voltage controller 404 may control the voltage Vcg between the cathode electrode 122 and the gate electrode 124 by adjusting the voltage of the cathode voltage Vc and/or the gate voltage Vg. As discussed above, the adjusted cathode electrode voltages Vc, gate electrode voltages Vg and/or anode voltages Va may compensate for deteriorating performance characteristics of the respective electron emission units 110 to enable the desired voltage difference Vcg between the cathode electrodes 122 and the gate electrodes 124 and/or the desired anode voltage Va. Thus, the lifetime of the electron emission units 110 may be increased.

In embodiments of the invention employing the PWM type data driver 200, the voltage controller 404 may generate the voltages, e.g., the cathode electrode voltage Vc, the anode electrode voltage Va and/or the gate electrode voltage Vg being supplied to the pixel unit 100.

The voltage controller 404 may supply the generated cathode electrode voltage Vc, the anode electrode voltage Va and/or the gate electrode voltage Vg to the DC converter 405. The DC converter 405 may change pulse widths of the voltage signals, e.g., the cathode electrode voltage Vc, the anode electrode voltage Va and/or the gate electrode voltage Vg, supplied by the voltage controller 404 before outputting the voltages to the respective voltage signal lines, e.g., the first, second and/or third voltage signal lines VS1, VS2, VS3.

As described above, when the external control signals EXTERNAL and/or the image signals IMAGE are supplied to the controller 500, the voltages, e.g., anode electrode voltages Va, gate electrode voltages Vg and/or cathode electrode voltages Vc being respectively supplied to the anode electrodes 132, the gate electrodes 124 and/or the cathode electrodes 122 may be adjusted based on the determined anode current Ia to increase the brightness of the respective electron emission unit 110 and to prolong the life-time of the electron emission units 110.

FIG. 5 illustrates a flowchart an exemplary method for controlling voltages of electron emission displays. As illustrated in FIG. 5, the method may begin at step S510 by the controller 500 receiving image signals IMAGE and/or external control signals EXTERNAL when, for example, power of the electron emission display is turned on or the external control signals EXTERNAL are changed. In step S510, the controller 500 may supply internal control signals INTERNAL to the power source supply unit 400 voltage controller 404 based on the received external control signals EXTERNAL and/or the received image signals IMAGE. As discussed above, the internal control signals INTERNAL may include signals controlling the power source supply unit 400 to determine the anode currents Ia. The internal control signals INTERNAL may also include the reference current value Iref.

The method may then proceed to step S520, during which the power source supply unit 400 may determine the anode current Ia. After determining the anode current Ia, the method may proceed to step S530 during which the power source supply unit 400 may compare the value of the determined anode current Ia to a corresponding reference current value Iref. If the power source supply unit 400 determines that the value of the determined anode current Ia is greater than the reference current value Iref, the method may end. If the power source supply unit 400 determines that the value of the determined anode current Ia is less than or equal to the reference current value Iref, the method may proceed to step S540.

In embodiments of the invention involving step S540, during S540, the power source supply unit may determine whether the voltage difference Vcg between the respective cathode electrodes 122 and gate electrodes 124 is at a predetermined maximum value for Vcg.

If the voltage difference Vcg is determined to be less than the predetermined maximum value for Vcg, the method may proceed to step S550. During step S550, the power source supply unit 400 may change the voltage difference Vcg by adjusting one or both of the cathode voltage Vc and the gate voltage Vg being supplied to the pixel unit 100. After adjusting the voltage difference Vcg, the method may return back to step S520 and the anode current Ia may, once again, be determined.

If, however, the voltage difference Vcg is determined to be at the predetermined maximum value for Vcg, the method may proceed to step S560. During step S560, as discussed above, the power source voltage unit 400 may adjust the anode voltage Va being supplied to the anode electrodes 132. The method may then return back to step S520 and the anode current Ia may, once again be determined. The method may end when it is determined that the value of the determined anode current Ia is greater than the reference current value Iref.

In embodiments of the invention, the step S540 may be avoided and the method may proceed from step S530 to step S560, discussed below. In embodiments of the invention, at step S530, it may be determined, for example, whether the value of the determined anode current Ia is greater than or equal to the reference current value Iref or whether the value of the determined anode current Ia is within or beyond a predetermined range. In embodiments of the invention, steps may be performed during the same time, e.g., steps S520 and S530 may occur at the same time.

As discussed above, in embodiments of the invention, even when the voltage difference Vcg between the gate electrodes 124 and the cathode electrodes 122 is at a maximum level, it is possible to adjust the anode voltage Va and still continue to increase the brightness of the electron emission units 110 and thereby further prolong the life-time of the electron emission units 110.

As described above, in electron emission displays and methods of controlling the voltages of electron emission displays employing one or more aspects of the invention, when the image signals IMAGE and/or the external input signals EXTERNAL are input and/or the power of the electron emission display is turned on, the anode currents Ia may be determined so that the anode voltages Va corresponding to the emission currents may be controlled and the brightness and the life-time of the electron emission devices and displays may be increased.

Exemplary embodiments of the invention have been disclosed herein, and although specific terms are employed, they are used and are to be interpreted in a generic and descriptive sense only and not for-purpose of limitation. Accordingly, it will be understood by those of ordinary skill in the art that various changes in form and details may be made without departing from the spirit and scope of the invention as set forth in the following claims.

What is claimed is:

1. An electron emission display, comprising:
a pixel unit including an anode electrode;
a controller, the controller receiving at least one of image signals and external control signals and outputting internal control signals to a power supply unit, the internal control signals including signals for determining anode current flowing through the anode electrode based on the received at least one of the image signals and/or the external control signals; and
a power supply unit, the power supply unit including:
a determining unit, the determining unit determining the anode current based on the internal control signals;
a comparing unit, the comparing unit comparing the determined anode current to a reference current value and outputting a comparison result; and
a voltage controller, the voltage controller adjusting an anode voltage signal to be supplied to the anode electrode based on the comparison result.

2. The electron emission display as claimed in claim 1, wherein the voltage controller adjusts the anode voltage signal to increase the anode current when the comparison result provides that the determined anode current is less than the reference current value.

3. The electron emission display as claimed in claim 2, wherein:
the pixel unit further includes a plurality of cathode electrodes and a plurality of gate electrodes,
the power supply unit supplies a cathode voltage signal, a gate voltage signal and the anode voltage signal to the cathode electrodes, the gate electrodes and the anode electrode, respectively, and
when the determined anode current value is less than the reference current value, the controller first adjusts at least one of the gate voltage signal and the cathode voltage signal before adjusting the anode voltage signal to drive the anode current to have a value closer to or equal to the reference current value.

4. The electron emission display as claimed in claim 1, further comprising:
a data driver, the data driver applying data signals to the pixel unit; and
a scan driver, the scan driver applying scan signals to the pixel unit.

5. The electron emission display as claimed in claim 4, wherein the controller outputs the data signals to the data driver and outputs the scan signals to the scan driver based on at least one of the received image signals and the received external control signals.

6. The electron emission display as claimed in claim 1, wherein:
the pixel unit further includes a plurality of cathode electrodes and a plurality of gate electrodes, and
the power supply unit is connected to the pixel unit via at least one voltage signal line and the power supply unit respectively supplies cathode voltage signals, gate voltage signals and the anode voltage signals to the cathode electrodes, the gate electrodes and the anode electrode based on the determined anode current value and the reference current value.

7. The electron emission display as claimed in claim 6, wherein:
when the comparison result provides that the anode current value is less than the reference current value, the controller determines whether a voltage difference between respective ones of the gate electrodes and the cathode electrodes is at a maximum amount,
when the controller determines that the voltage difference is below the maximum amount, the controller controls the power supply unit to adjust at least one of the cathode voltage signal and the gate voltage signal, and
when the controller determines that the voltage difference is at the maximum amount, the controller controls the power supply unit to adjust the anode voltage signal.

8. The electron emission display as claimed in claim 7, wherein the voltage difference is at the maximum amount when one of the cathode voltage signal and the gate voltage signal is respectively at a maximum cathode voltage signal value and a maximum gate voltage signal value and the other one of the cathode voltage signal and the gate voltage signal is respectively at a minimum cathode voltage signal value and a minimum gate voltage signal value.

9. The electron emission display as claimed in claim 1, wherein the internal control signals further include signals to the power supply unit to control at least one of a value and a pulse width of the anode voltage signal being supplied to the anode electrode.

10. The electron emission display as claimed in claim 1, wherein the power supply unit further comprises a microcomputer, the microcomputer receiving the internal control signals from the controller and outputting voltage signals to the voltage controller.

11. The electron emission display as claimed in claim 8, wherein the power supply unit further comprises a DC converter, the DC converter receiving the anode voltage signals from the voltage controller and converting pulse widths of the anode voltage signals.

12. A method of controlling a display including an anode electrode, cathode electrodes and gate electrodes, the method comprising:
receiving at least one of image signals and external control signals;
determining an anode current value for anode current flowing through the anode electrode based on the received at least one of the image signals and the external control signals;
comparing the determined anode current value with a reference current value and outputting a comparison result; and
adjusting an anode voltage signal to be supplied to the anode electrode based on the comparison result.

13. The method of controlling a display as claimed in claim 12, wherein adjusting the anode voltage signal includes adjusting the anode voltage signal when the comparison result provides that the determined anode current is less than the reference current value, in order to drive the anode current value to be closer to or equal to the reference current value.

14. The method of controlling a display as claimed in claim 12, further comprising:
determining whether a voltage difference between respective ones of the gate electrodes and the cathode electrodes is at a maximum amount when the comparison result provides that the anode current is less than the reference current value.

15. The method of controlling a display as claimed in claim 14, wherein adjusting the anode voltage signal includes:
adjusting at least one of a cathode voltage signal and a gate voltage signal when it is determined that the voltage difference is less than the maximum amount, and
adjusting the anode voltage signal when it is determined that the voltage difference is at the maximum amount.

16. The method of controlling a display as claimed in claim 14, wherein adjusting the anode voltage signal includes adjusting one of a value and a pulse width of the anode voltage signal.

17. An electron emission display, comprising:
a pixel unit including an anode electrode;
controlling means for receiving at least one of image signals and external control signals and for outputting internal control signals;
determining means for determining an amount of anode current flowing through the anode electrode based on the internal control signals;
comparing means for comparing the determined amount of anode current to a reference current value and outputting a comparison result; and
voltage controlling means for adjusting an anode voltage signal to be supplied to the anode electrode based on the comparison result.

18. The electron emission display as claimed in claim 17, wherein:
the pixel unit further includes a plurality of cathode electrodes and a plurality of gate electrodes,
when the comparing means outputs that the determined anode current is less than the reference current value, adjusting the anode voltage signal in order to drive the anode current value to be closer to or equal to the reference current value, and
the voltage controlling means adjusts at least one of a gate voltage signal and a cathode voltage signal to be respectively supplied to the gate electrodes and the cathode electrodes before adjusting the anode voltage signal.

19. The electron emission display as claimed in claim 18, further comprising:
voltage difference determining means for determining whether a voltage difference between respective ones of the gate electrodes and the cathode electrodes is at a maximum amount when the comparison result provides that the anode current value is less than the reference current value.

20. The electron emission display as claimed in claim 19, wherein the voltage adjusting means:
adjusts at least one of the cathode voltage signal and the gate voltage signal when it is determined that the voltage difference is less than the maximum amount, and
adjusts the anode voltage signal when it is determined that the voltage difference is equal to the maximum amount.
